(19) United States
(12) Patent Application Publication
(10) Pub. No.: US 2013/0239709 A1
(43) Pub. Date: Sep. 19, 2013

(54) MULTI-FUNCTION MEASUREMENT AND SIGNAL GENERATION DEVICE WITH APPLICATION SELECTOR

(71) Applicants: Casper Dolleris, Vancouver (CA); Claus Dolleris, Skibby (DK)

(72) Inventors: Casper Dolleris, Vancouver (CA); Claus Dolleris, Skibby (DK)

(73) Assignee: Dolleris Scientific Corp., Vancouver (CA)

(21) Appl. No.: 13/423,776

(22) Filed: Mar. 19, 2012

(51) Int. Cl. G01D 7/02

(52) U.S. Cl. 73/866.3

(57) ABSTRACT

A device for measurement and signal generation having multiple different test and measurement applications and an application selector to choose which application is currently active, the device having a graphical screen selector and an input mechanism to enable application selection. The applications use a graphical display of measurement data or input parameters, and each application uses available measurement hardware for different measurement functions to reduce the need for several individual measurement devices. Various test and measurement applications are provided for any specific type of measurement or signal generation. They will typically measure or generate signals in various test and measurement domains, such as high precision multi-meter type measurements, industrial control, signal generator application, audio, communication, device characterization, data logging, etc.

### BACKGROUND

1. Technical Field Disclosure

The present disclosure relates generally to test, measurement, signal generation and similar research and development as well as industrial control devices and methods.

2. Description of the Related Art

Test and measurement, or alternatively, measurement and signal generation, is typically used as a description for any measurement or signal generation function that receives at least one input from an electrical input or a sensor and that can optionally generate one or more outputs to an electrical output connector or other signal receiving unit.

Measurement domains refers generally to measurement functions typically handled by different measurement instruments, such as volt meters, audio measurement, power supplies, waveform generators, optical measurements, communication analyzers, PID controllers etc. These are examples of instruments that work in different measurement domains.

### BRIEF SUMMARY OF THE DISCLOSURE

With the availability of flexible user interfaces, graphical screens and fast signal processors, new possibilities arise in the design of test and development equipment.

The traditional test and measurement instruments are mostly dedicated devices within each measurement domain such as; oscilloscopes, digital multi-meters, signal generators, PID controllers, electronic loads, power supplies, optical power meters, temperature meters etc.

By analyzing the hardware in many of these devices it was observed that the same signal input hardware and in some cases output hardware is present in many of them. The device presented here has flexible input measurement hardware and optionally output generation capabilities, and by designing the underlying hardware in a specific way the same instrument can support most of these measurement and signal generation types.

For each measurement type, software application code controls the available hardware in a specific way. These software applications can interact with the hardware to fit the specific function required. An application selector will enable the user to select which one of the measurement applications is running and controlling the measurement and signal generation hardware, and the graphical display in the device will show values, parameters, and user selections specific to that measurement application.

Of the instruments in existence today the digital multi-meter is well known. However, this type of instrument has fixed selectors for the measurement types and fixed measurement types on small dedicated displays. It does not have a flexible application selector that can be upgraded or modified. Further they only support signal measurement, not signal generation or any other more advanced type of signal processing.

The described approach with an application selector is very flexible, and one instrument will be able to support and replace many dedicated test and measurement instruments. Further enhancing flexibility is the support for uploading new measurement applications from a host. A user requiring a special measurement or signal generation type could upload a new instrument definition that will be present in the application selector and re-use the underlying hardware.

Some approaches to this are signal acquisition cards or modules that can be configured by a host to perform a measurement or control job, but these instruments lack the flexible application selector, graphical screen and self-contained operation of the instrument described here.

Examples of measurement types and instruments that can be supported with just one available input;
Standard voltage and current measurements
Panel meters
Oscilloscopes
Data loggers
Thermometers

Multiple inputs can support multi-channel operations or more advanced measurement and signal processing applications.

Typical instrument types with an output could be:
Power supplies
Signal generators
PID controllers
Audio analyzers
Power drivers
Battery chargers/analyzers

These are just examples of typical instruments that can be designed and selected in an application selector based on the same hardware.

For multi-channel units each channel can run the same software and applications, but have individual application selectors and in some implementations individual processing units thereby running different measurement and test applications in the same physical device.

The physical implementation of these devices can be in the form of hand-held battery operated units, desktop units for R&D purposes, industrial type units for rack mounting or any other form factor that is required.

### DESCRIPTION OF THE SEVERAL VIEWS OF THE DRAWINGS

The foregoing and other features and advantages of the present disclosure will be more readily appreciated as the same become better understood from the following detailed description when taken in conjunction with the following drawings, wherein:

FIG. 1 is a block diagram of a test and measurement system formed in accordance with the present disclosure;

FIG. 2 is a block diagram of another example of a test and measurement system formed in accordance with the present disclosure;

FIG. 3 illustrates an application selector menu for use with the systems of FIGS. 1 and 2;

FIG. 4 illustrates an application selected by the application selector of FIG. 4;

FIG. 5 illustrates a power supply application selected by the application selector of FIG. 4;

FIG. 6 shows an example implementation of an handheld device formed in accordance with the present disclosure; and

FIG. 7 illustrates a representative R&D type instrument with two channels formed in accordance with the present disclosure.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures or components or both associated with measurement and test devices, including multi-meters, signal generators, and the like have not been shown or described in order to avoid unnecessarily obscuring descriptions of the embodiments.

Unless the context requires otherwise, throughout the specification and claims that follow, the word “comprise” and variations thereof, such as “comprises” and “comprising” are to be construed in an open inclusive sense, that is, as “including, but not limited to.” The foregoing applies equally to the words “including” and “having.”

Reference throughout this description to “one embodiment” or “an embodiment” means that a particular feature, structure, or characteristic described in connection with the embodiment is included in at least one embodiment. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

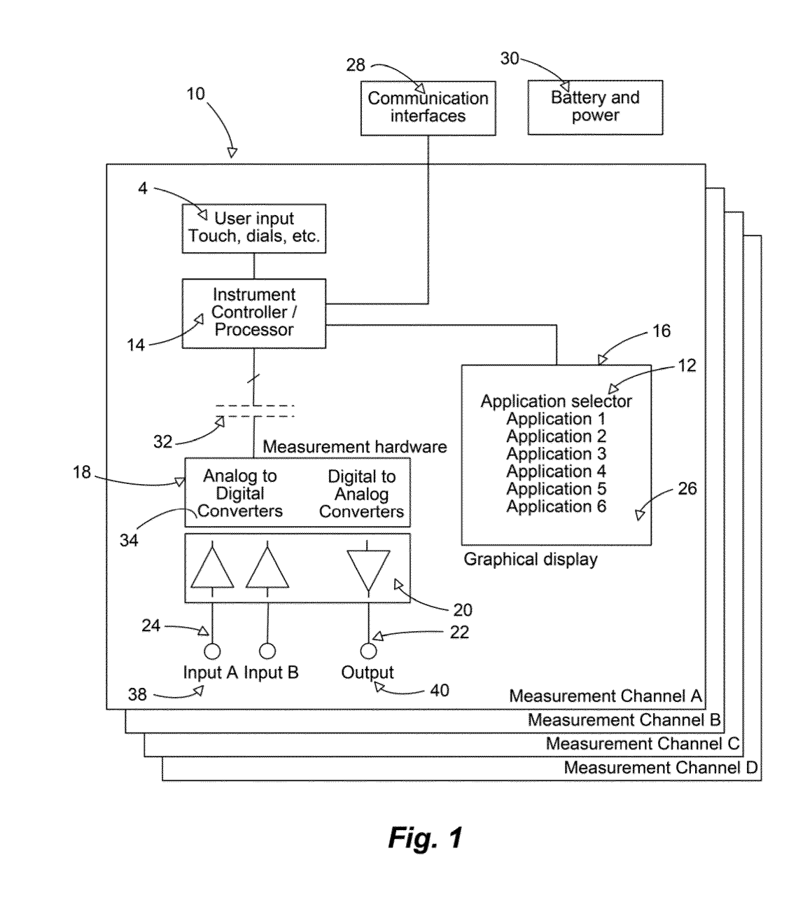

FIG. 1 is a block diagram that shows a representative example of an overall test and measurement system 10 that includes an application selector 12, an application processor 14, a graphical display 16 and a measurement front-end 18, 20, 22, and 24. In this embodiment each channel has a controller 14 and a display 16 to show the application selector 12 and applications 26. Four channels are shown.

The device may have communication interfaces 28 and battery operation provided by batteries 30.

The hardware front end typically consists of electrical isolation 32, analog to digital converters and digital to analog converters 34, input buffers, amplifiers and attenuation 36, input(s) 38 and output(s) 40.

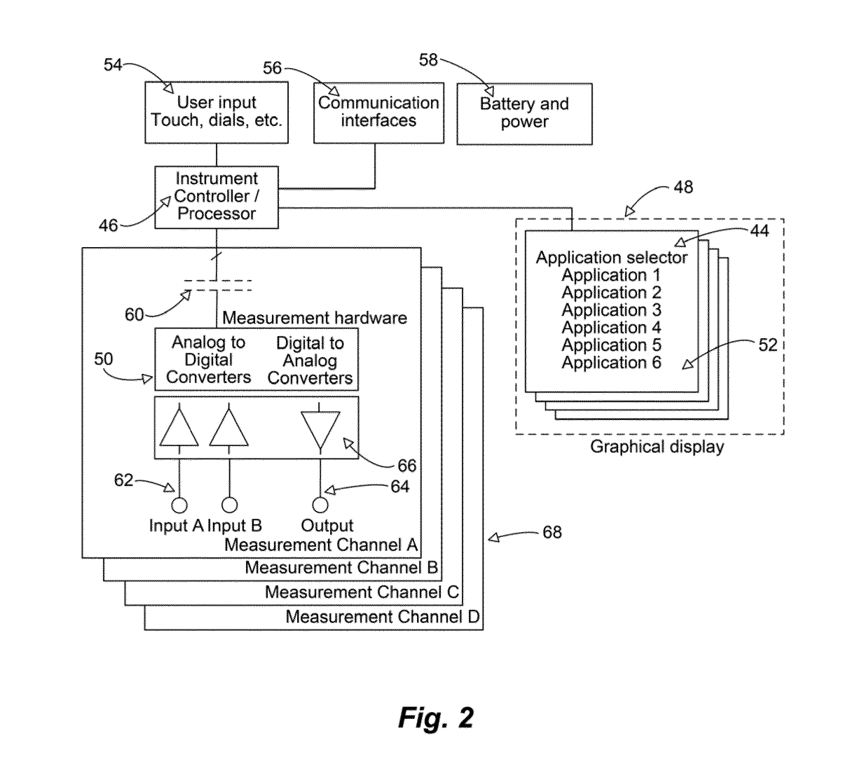

FIG. 2 shows another example of the overall test and measurement system 42 concept with an application selector 44, an application processor 46, a graphical display 48 and a measurement front-end 50. In this embodiment a common processor controls multiple channels, but uses only one graphical display 48 for displaying multiple of application selectors 44 and applications 52.

Also shown are a user input 54, communication interfaces 56, and a source of stored power, such as a battery 58. Electrical isolation 60 is also provided between the instrument controller/processor 46 and the measurement hardware 50. As in the first example system, inputs 62 and an out 64 are provided that connect to the input buffers, amplifiers, and attenuation devices 66. Four measurement channels 68 are shown in this system to correspond to the four applications 42.

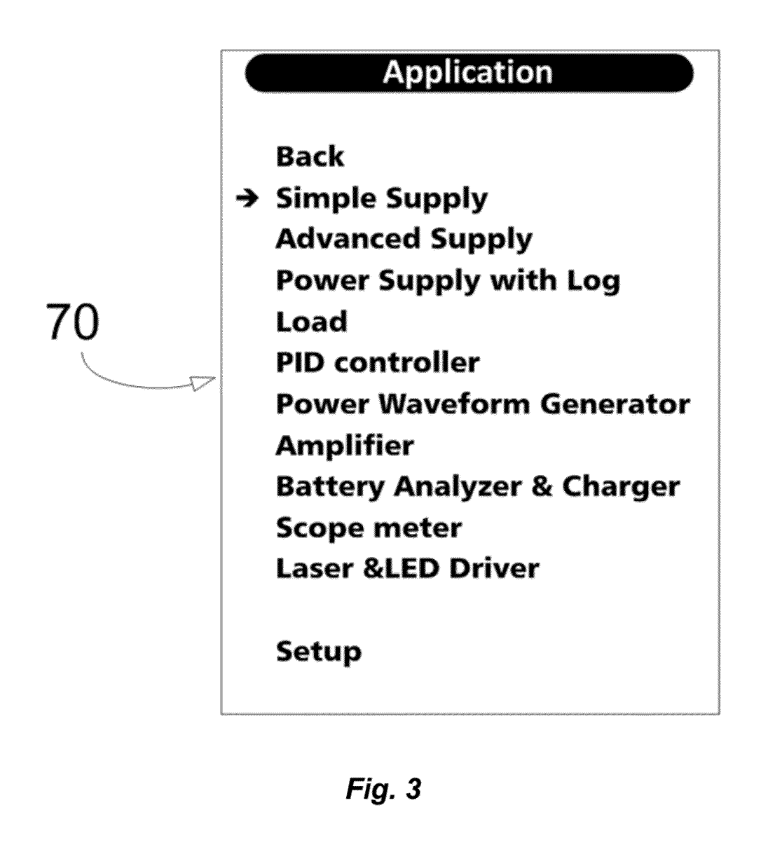

FIG. 3 shows a typical application selector menu 70; this can be based on text, graphical symbols or a combination thereof.

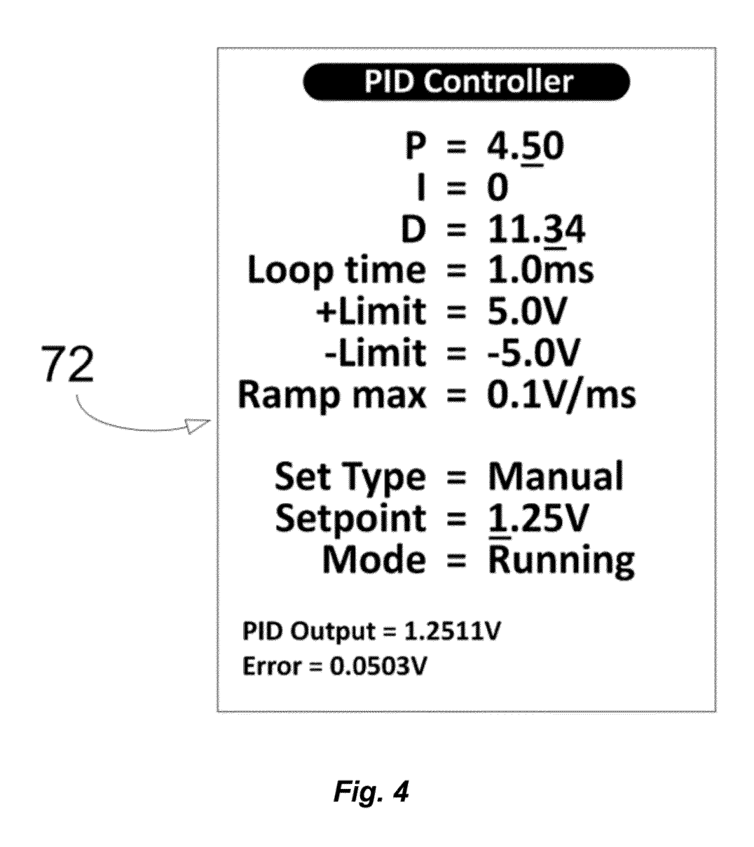

FIG. 4 shows a typical application 72 selected by the application selector. In this case a PID controller application is shown.

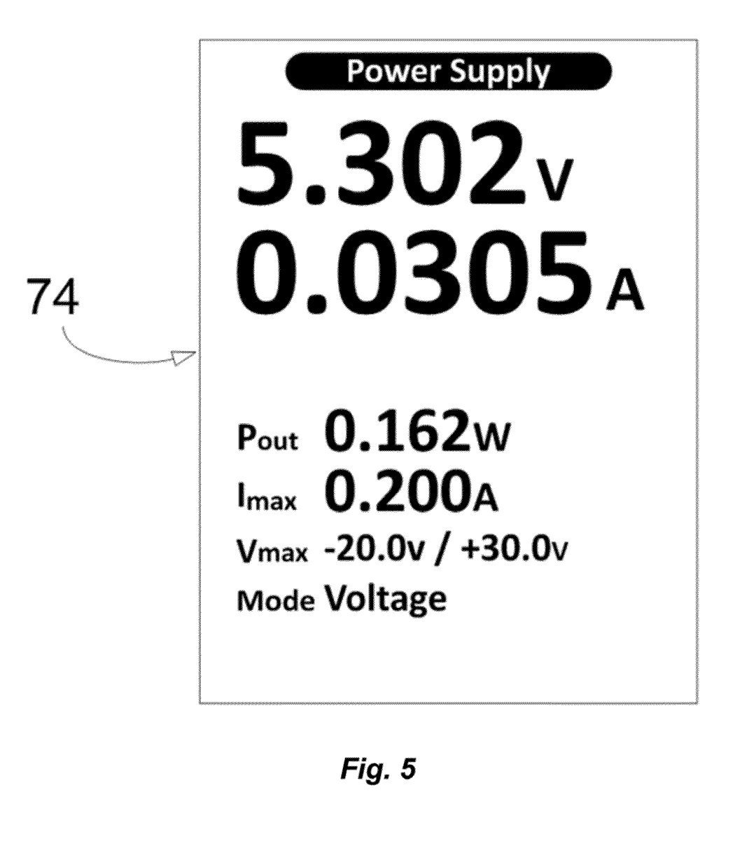

FIG. 5 shows another typical application, in this case a power supply application 74.

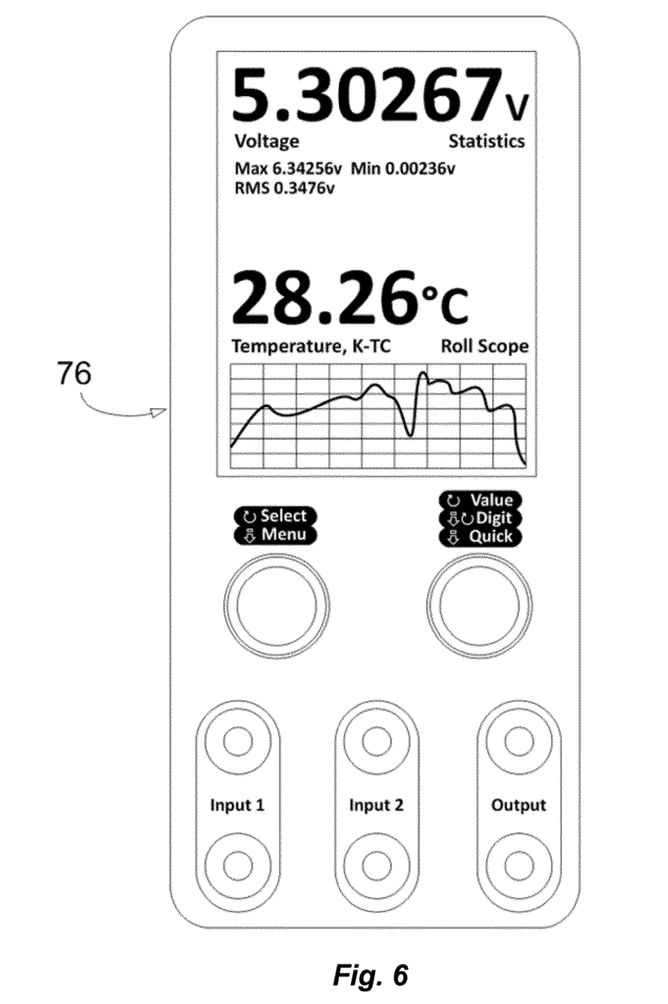

FIG. 6 shows an example implementation where the device is built in a handheld format 76.

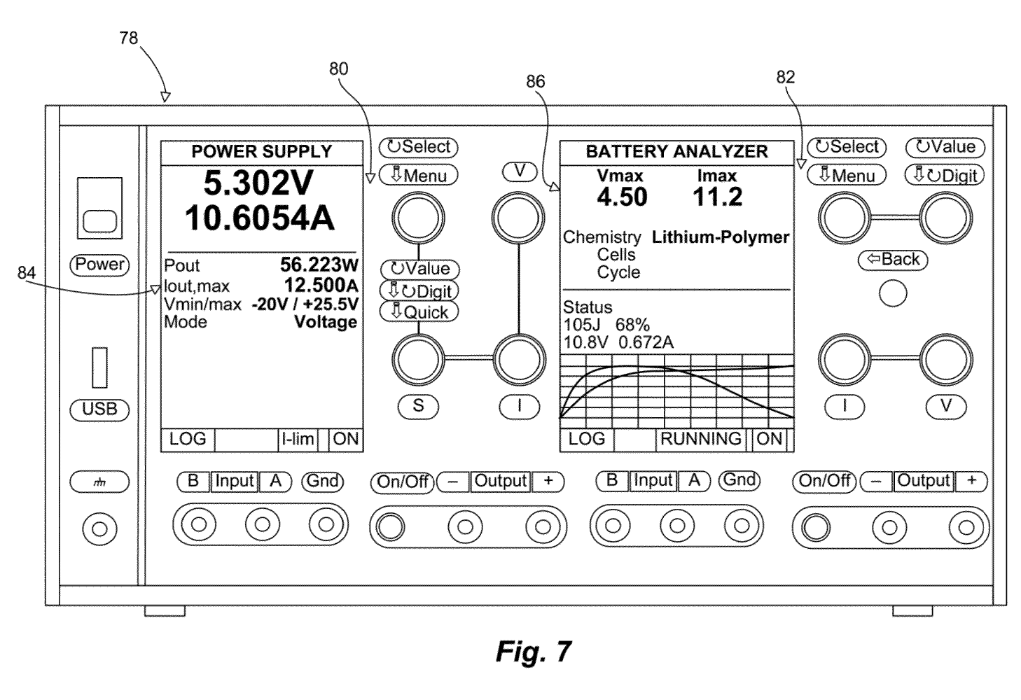

FIG. 7 shows an example of a R&D type instrument 78 with two channels 80, 82 showing two different applications 84, 86 running the same overall software.

This systems and devices shown and described herein are unique in their approach because they are not limited to specific test and measurement applications, such as DMMs, oscilloscopes, signal generators, temperature controllers, programmable logic controllers etc. These systems and devices can perform all these functions, in a self-contained instrument, only limited by the available inputs, outputs, and the design of the hardware front-end. The hardware front-end is designed to be generic and cover a wide range of input specifications, samples rates and resolutions. The application selector selects the application and the selected application controls the front-end hardware to determine the specific test and measurement function. This approach offers almost unlimited flexibility.

When an application is running it takes complete control of the available measurement and signal generation hardware, as well as external inputs and outputs. The application can perform any function within the constraints of the implemented hardware.

The representative systems and devices described here use a graphical display for displaying the application selector and measurement and signal generation applications. The graphical display can be of types such as TFT, LCD, OLED, VFD or other types of graphical displays in monochrome, grayscale or color. An embedded computer such as a microcontroller, signal processor or application processor can control the pixels on the display to show text and graphical data in the form of graphs, curves, trends and other graphical representations.

The application selector is software defined and can be updated and changed by upgrading the software, or a remote computer can update the application selector to add or remove applications on the device. Each application selector item corresponds to a software defined application that performs measurement functions, signal generation functions, signal processing and transformation as well as user interaction. The applications can optionally be remotely updated to allow changes or new functionality.

The application selector can be implemented in various ways, but will typically be a list or a grid of text or icons, or a combination thereof, that describe or illustrate the test and measurement application.

When a measurement or signal generation application is selected the display shows values and data related to this application. These values can be measurement of input data, processed data, scaled data, filtered data or any other signal processing function as well as graphical data or any other representation.

The devices described herein are multi-purpose devices and will have at least two different measurement applications, but typically many more applications that perform different functions and displays different measurement or signal generation data. Applications will typically be spread over different measurement domains, such as industrial, audio, precision measurement, sensor reading etc., but they may also have variations of different applications within the same domains.

The user can select between these applications on a touch screen or with a rotary dial or other selection means. The embedded controller receives this input and shows a corresponding software defined application on the display. These devices can have multiple channels each with an independent application selector for performing measurements and signal generation on each channel.

At least one measurement input is provided, and will typically have two or more measurement inputs for performing more advanced measurements and can optionally have one or more signal generation outputs for generation of waveforms or for outputting signals related to the input.

In a preferred embodiment there are two high resolution measurement inputs that can sample with very high precision, using an analog to digital converter, with typically 16, 24, or 32-bits resolution and with sample rates from a few samples per second to millions of samples per second. Two additional analog to digital converters on the same two inputs can sample with lower resolution such as 8-bits, 10-bits or 12-bits with higher resolution such as 10 Msamples/sec, 100 Msamples/sec or 1 Gsamples per sec or higher to broaden the measurement functions. The inputs can have comparators for high speed digital input functions and buffers and attenuation hardware for minimal load of the input source.

In a preferred embodiment there are one or more outputs for signal generation as well. These outputs can be controlled using digital to analog converters and they can be amplified to source signal level currents or high current applications. In a typical preferred embodiment these outputs will supply 10 mA to 25 A. These outputs can be amplified outputs for DC sourcing such as a power supply, or as a driver for waveform generation for driving coils, motors, LEDs, lasers, or any other device.

The inputs will in the preferred embodiment have electrical isolation between the measurement front end and the embedded processor, so that the measurement inputs and signal generation outputs are not affected by ground levels or the electrical potential of other channels. This ensures that the measurement input/outputs can be safely connected to any circuit.

In the preferred embodiment the inputs can act as differential or single ended inputs to increase versatility. Used as single end inputs, each input can measure individually, whereas in differential mode they can act as sense inputs in power supply applications etc.

Examples of different measurement and signal generation functions:
Digital Multi-meter, voltage measurement, current measurement, resistance measurement.
Oscilloscope, dynamic voltage measurement.
Signal generator/waveform generator
Temperature measurement from thermocouples, NTCs, PTCs, semiconductors, PT 100 or other sensors.
Power supply, voltage driver, current driver, power driver
PID controller
Programmable amplifier
Programmable filter
Lock in amplifier
Device characterization with sweeping functions, such as testing I/V relations of semiconductors.
Driver for LEDs and laser sources
Coil driver, drivers, speakers, solenoids, galvanometers etc.
Motor driver for DC motors, step motors, brushless motors and other motor types with encoder inputs.
Programmable thermostat
Oscilloscope amplifier and measurement front end with differential inputs
Programmable logic controller for industrial control
Programmable industrial test controller
Production monitoring and documentation
Battery chargers, analyzer, characterization tool for multi-battery chemistry
Characterization of power supplies
Programmable electronic load
Programmable advanced load with capacitive, inductive, resistive and other modes.
Communication line characterization and test and evaluation
Driver and controller for oven heating elements and temperature sequencing
Production monitoring with alarm and stop functions for production lines.
Data logging and trend logging with non-volatile memory
Sensor measurement, such as strain gauges, hygrometers, mems sensors, accelerometers, photo diodes, PH sensors, Hall sensors etc.
Driver for peltier elements with temperature control.
Digital I/O driver with communication interface simulation, such as SPI, I2C, UART etc.
Pulse generator and pulse capture function.
Power analyzer, efficiency, watts consumed, energy etc.
Energy meters, short or long term energy measurement for AC or DC sources.
Drivers, converters and loads for solar panels.
High current measurement.
Environmental measurement station.
High current light source (laser Led etc) driver with feedback and control.
Audio analyzer
Panel meter
Insulation and short circuit tester.
Fan controller
LCR meter

This is a list of examples of general measurement and signal generation applications that can be implemented within the same device. This flexibility in combination with multiple independently operating channels gives tremendous flexibility and functionality as it reduces the need to invest in multiple instruments.

Other than generic measurement and signal generation functions, very specific functions can be created in separate applications by adding a minimum of hardware to the generic inputs/outputs. A few examples of this could be:
Machine coordinate display
Power quality meter
Weight scale based on strain gauge
IR thermometer based on pyrometers or thermo electric cells.
Color detector/calibrator
Sound level meter.
Controller for optical scanner.

Different measurement domains, such as electrical measurement, optical measurements, sensor measurements, drivers, PID controllers, digital control functions, audio, battery are all combined into one instrument with readout in the units that correspond to the measurement domain for clear and easy interpretation.

A host based or internal application generator can be used to create new or derived applications. As an example, if a PID controller with a temperature input is required to stabilize a heat plate, the important parameter could be the temperature of the heat plate, or the power required to the heat plate or a derived temperature measurement in another location in the test setup. By creating a new derived application from a PID controller application other display values can be added or logged into non-volatile memory, thereby adding a customized application to the application selector without changing any of the other existing applications and measurement capabilities.

A community of user derived applications could be uploaded and managed in an online database and reused by other users of the device, much like software on generic computers, but relying on well-defined measurement and signal generation hardware.

In signal generation applications output waveforms may be simple square wave, sine, triangle and other standard waveforms, but may also be much more complex waveforms either computed or derived from input measurements. An example of this could be a PID controller that bases its output on a reference and a feedback input, or advanced filtering of inputs with simple filters or complex filters.

A non-volatile memory in the device, such as EEPROM, flash, battery backed up RAM, hard disk drive or other type of memory may be used to save measurement values for later display or processing. In a typical data-logger application samples are measured at regular intervals and display in a compressed graph later or uploaded to a host system. With the integration of non-volatile memory the device can be powered off and moved to a new location without losing measurement data.

In a preferred embodiment the device will typically have a number of host interfaces such as USB, Ethernet, CAN or other communication interfaces that will enable upload of measurement data to a host or download of new or revised applications on the device or pre-defined measurement data.

These interfaces are optional and the device will be able to operate independently displaying its data on the graphical screen and the device can, for complete self-containment, have an internal power source, such as a lithium ion, lithium polymer, NiMh, NiCd or other type of battery, that may be embedded in the device. Unlike other host controlled sampling and measurement devices, this device will be able to work completely self-contained.

The host communication hardware may also be used for inter-device communication and exchange of data, enabling one device to send measurement data to another device. This could prove very useful if the number of inputs or outputs required for a measurement application exceed the number of inputs/outputs available on one device.

Another feature that may be implemented is a time synchronization feature that will enable multiple measurement channels to acquire synchronized measurement data. In a typical 16-channel input measurement application, 8 measurement channels with 2 inputs on each could be synchronized to sample at the same time. This synchronization feature could be implemented via a simple trigger signal or as part of a CAN interface or Ethernet interface with time syncing features or other similar ways.

The device may be designed in various physical formats. In a preferred embodiment, the device will be a two channel desktop device with one graphical screen to control both channels, but with two independent application selectors. The device and technology are not limited to a specific physical implementation. One unit could have eight channels in a desktop device, another could be a small hand-held device for field service and diagnostic, yet again other implementations may include rack mounted unit or DIN rail device with one or more channels.

These devices may be used in many locations such as in R&D labs, production lines, industrial control, field service, home use, remote sensing or any other location.

In all embodiments the application selector and the applications themselves are software defined. In some embodiments the application selector and applications can be upgraded, deleted, modified or otherwise changed to suit a specific measurement application either remotely or by using a local feature.

The various embodiments described above can be combined to provide further embodiments. Aspects of the embodiments can be modified, if necessary to employ concepts of the various patents, application and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. A test and measurement device comprising:
a. at least one graphical display with individually addressable pixels;
b. at least one software defined application selector displayed on the graphical display;
c. a plurality of built-in software defined test and measurement applications that can be selected with the application selector;
d. a user input system structured to enable a user to make a selection in the application selector; and
e. at least one controller structured to receive application selections from the user input system and to process measurement inputs and displaying measurement data.

2. The device according to claim 1 wherein each test and measurement application displays different measurement parameters.

3. The device according to claim 1 wherein the application selection is performed by using a rotary dial.

4. The device according to claim 1 wherein the application selection is performed by a touch function on the graphical screen.

5. The device according to claim 1 having at least one input structured to measure a signal and at least one output for generating a signal.

6. The device according to claim 1 having a non-volatile memory structured to store measurement data and later display the stored measurement data on the graphical screen.

7. The device according to claim 1 having one or more communication interfaces structured to exchange measurement data with a remote computerized unit.

8. The device according to claim 1 wherein each application function in the application selector is based on one of the following elements:
a. an icon representing the measurement function;
b. text representing the measurement function; and
c. a combination of icon and text representing the measurement function

9. The device according to claim 1 wherein the test and measurement functions in the application selector is structured to display values in different measurement domains selected from among optical parameters, electrical parameters, temperature parameters, power parameters, time parameters, communication parameters, audio parameters, signal generation parameters, industrial control parameters.

10. The device according to claim 1 wherein each test and measurement application is structured to use a graphical display with individually addressable pixels.

11. The device according to claim 1 wherein the graphical display is a color display.

12. The device according to claim 1 wherein the application selector is configurable so that the number of applications and application types can be changed.

13. The device according to claim 1 wherein multiple devices is structured to be synchronized in time through use of a communication interface to obtain substantially time related measurement data on the two or more devices.

14. The device according to claim 1 wherein each test and measurement application is structured to be remotely configurable over a communication interface to the device.

15. The device according to claim 1 wherein the device has at least two measurement inputs and two signal generating outputs.

16. The device according to claim 1 wherein the device has a USB interface for communication with a remote system.

17. The device according to claim 1 wherein the device has an Ethernet interface for communication with a remote system.

18. The device according to claim 1 wherein the device is structured to operate in a self-contained mode without any communication with hosts or other outside equipment.

19. The device according to claim 1 wherein the application selector is configurable so that the number of applications and application types can be changed.

20. The device according to claim 1 wherein the device has multiple channels, each channel having an application selector structured to control which measurement application is in use for each channel.

21. The device according to claim 1 wherein the input section of the device is electrically isolated from the user interface components and from other measurement channels.

22. The device according to claim 5 wherein the at least one output includes an electrical power source able to generate an output current of at least 1 amp and at least 5 volts.

23. The device according to claim 12 wherein the application selector is structured to be remotely changed over a communication interface to the device.

24. The device according to claim 5 wherein the device has a programmable computing unit that is structured to process input signals and calculate output signals based on the setting of the application selector.

25. The device according to claim 9 wherein the device is structured to display values in three or more measurement domains.

26. The device according to claim 1 wherein each signal generation and measurement channel is structured to send and receive measurement data for further processing over a communication interface between the channels.

27. The device according to claim 1 wherein each measurement and signal generation application is structured to completely control the at least one measurement input associated with the application selector on the device.

28. A device with at least one input for performing an electrical measurement and at least one output for electrical signal generation, the device comprising;
a. at least one graphical display with individually addressable pixels;
b. at least one selector displayed on the graphical display for choosing between multiple different software defined measurement and signal generation applications;
c. a multiple of software defined measurement and signal generation applications; and
d. at least two of the multiple measurement and signal generation applications structured to perform different measurement and signal generation functions in different measurement domains.

29. The device according to claim 28 having one or more communication interfaces structured to exchange measurement data with a remote computerized unit.

30. The device according to claim 28 wherein the application selector is configurable so that the number of applications and application types can be changed.

31. The device according to claim 28 wherein the measurement and signal generation applications are configurable so that the function of each measurement and signal generation application can be changed.

32. The device according to claim 28 wherein the device is structured operate in a self-contained mode without any communication with hosts or other outside equipment.

33. The device according to claim 28 having a non-volatile memory structured to store measurement data and to later display the stored measurement data on the graphical screen and to export the measurement data to a remote system.

34. The device according to claim 28 wherein each measurement and signal generation application completely controls the measurement input and signal generation output associated with the channel selector on the device.
